(19) United States
(12) Patent Application Publication
(10) Pub. No.: US 2002/0089478 A1
(43) Pub. Date: Jul. 11, 2002

(54) Image display apparatus

(76) Inventor: Shouichi Yokobori, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/022,256

(22) Filed: Dec. 20, 2001

(30) Foreign Application Priority Data
Dec. 25, 2000 (JP) 2000-393408

(51) Int. Cl. G09G 3/36

(52) U.S. Cl. 345/87

(57) ABSTRACT

In an image display apparatus, two gamma correction values, e.g., a gamma correction value (γ_{A}) for movie playback and a gamma correction value (γ_{B}) for graphic display are prepared in advance. To display on an LCD, e.g., an image made up of a playback portion of a movie and a display portion of a graphic, an MPU executes switching such that an LCD controller uses the gamma correction value (γ_{A}) when image data output from a decoder is one for movie playback within a window, and executes switching such that the LCD controller uses the gamma correction value (γ_{B}) when image data is one for graphic display outside the window.

### CROSS-REFERENCE TO RELATED APPLICATIONS

This application is based upon and claims the benefit of priority from the prior Japanese Patent Application No. 2000-393408, filed Dec. 25, 2000, the entire contents of which are incorporated herein by reference.

### BACKGROUND OF THE INVENTION

1. Field of the Invention

The present invention relates to an image display apparatus for controlling the display of an image on an LCD (Liquid Crystal Display) or the like and, more particularly, to an image display apparatus capable of displaying respective image data to be simultaneously displayed on a single display screen with proper colors.

2. Description of the Related Art

In recent years, LCDs are widely spread, and the image processing ability of computers or the like has dramatically improved. In this regard, it becomes usual to open a window in part of the display screen of an LCD and play back a moving picture, such as a movie, within this window.

An LCD has a predetermined ability of reproducing a color in one pixel, and some image data to be displayed requires color conversion by gamma correction. In general, this color conversion is uniformly executed for the entire display screen.

Recently, a moving picture is played back within a window opened on a display screen, as described above. If gamma correction is applied to the moving picture in this window, it is not always displayed with proper colors. Similarly, if any image data outside the window preferentially receives gamma correction, the moving picture in the window may be displayed with improper colors.

### BRIEF SUMMARY OF THE INVENTION

The present invention has been made in consideration of the above situation, and has as its object to provide an image display apparatus capable of displaying respective image data to be simultaneously displayed on a single display screen with proper colors.

To achieve the above object, an image display apparatus according to the present invention can set a gamma correction value from an MPU or the like. For this purpose, there is provided an image display apparatus comprising: a gamma correction value setting device configured to set a gamma correction value representing an input/output characteristic of the image display apparatus; and a gamma correction device configured to execute gamma correction for image data by using the gamma correction value set by the gamma correction value setting device.

The gamma correction value setting device preferably sets different gamma correction values for a plurality of portions segmented on a single display screen.

In the image display apparatus of the present invention, when a window for playing back a moving picture is opened on part of the display screen, the inside of the window, i.e., a region where a movie or the like is played back, and the outside of the window, e.g., a region where a graphic such as the wallpaper is displayed can be color-converted by externally supplying different gamma correction values. Respective images to be simultaneously displayed on a single display screen can be displayed with proper colors.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a block diagram showing the configuration of an image display apparatus according to embodiments of the present invention;

FIG. 2 is a block diagram for explaining gamma correction executed by the LCD controller of the image display apparatus according to the first embodiment;

FIG. 3 is a flow chart showing the operation procedures of gamma correction executed by the LCD controller of the image display apparatus according to the first embodiment;

FIG. 4 is a view showing an image which is made up of a playback portion of a movie and a display portion of a graphic and is to be displayed on an LCD by the MPU of an image display apparatus according to the second embodiment;

FIG. 5 is a table for explaining a register incorporated in the LCD controller of the image display apparatus according to the second embodiment;

FIG. 6 is a flow chart showing the operation procedures of gamma correction executed by the LCD controller of the image display apparatus according to the second embodiment;

FIG. 7 is a block diagram for explaining gamma correction executed by the LCD controller of an image display apparatus according to the third embodiment; and

FIG. 8 is a flow chart showing the operation procedures of gamma correction executed by the LCD controller of the image display apparatus according to the third embodiment.

### DETAILED DESCRIPTION OF THE INVENTION

Embodiments of the present invention will be described below with reference to the several views of the accompanying drawing.

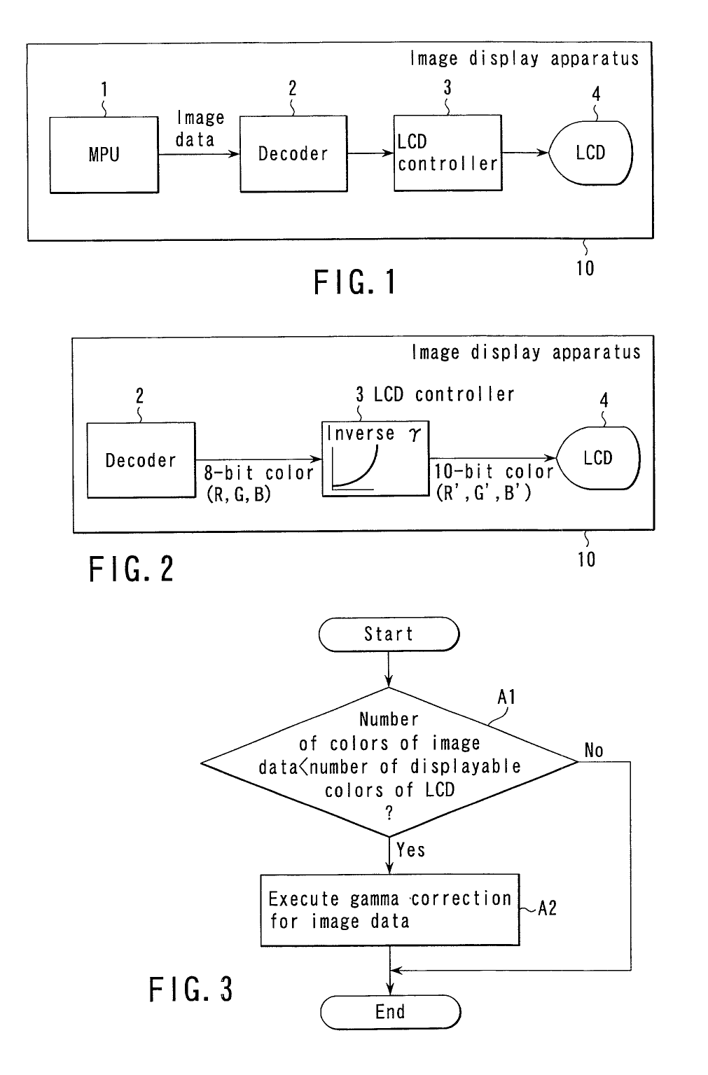

FIG. 1 is a block diagram showing the configuration of an image display apparatus through the embodiments.

As shown in FIG. 1, an image display apparatus 10 comprises an MPU (Micro Processing Unit) 1, decoder 2, LCD controller 3, and LCD 4.

The MPU 1 reads out image data which is compressed, coded, and recorded on a recording medium such as a DVD (Digital Versatile Disc), and transfers it to the decoder 2. The decoder 2 decompresses and decodes the image data such as a moving or still picture received from the MPU 1, and transfers it to the LCD controller 3. The LCD controller 3 converts the image data which has been decompressed and decoded by the decoder 2 into display data for the LCD 4, and drives and controls the LCD 4 for display based on the display data.

When converting the image data received from the decoder 2 into display data for the LCD 4, the LCD controller 3 executes correction considering the I/O characteristic of the LCD 4, i.e., gamma correction. The feature of the image display apparatus is to enable dynamically setting a gamma correction value used for gamma correction, thereby displaying respective images to be simultaneously displayed on a single display screen with proper colors. This will be described in detail below.

(First Embodiment)

FIG. 2 is a block diagram for explaining gamma correction executed by an LCD controller 3 according to the first embodiment.

As shown in FIG. 2, the number of colors of image data output from a decoder 2 is expressed by 8 bits, and is smaller than 10 bits which is the number of colors of image data supplied from the LCD controller 3 to an LCD 4. That is, the quality of image data is inferior to the display ability of the LCD 4.

In this case, an MPU 1 resets a gamma correction value (inverse γ) used by the LCD controller 3 so as to display image data expressed by 8-bit color on the LCD 4 with proper colors. Using this gamma correction value, the LCD controller 3 executes gamma correction on the image data. FIG. 3 is a flow chart showing the operation procedures of gamma correction in the first embodiment.

In this manner, an image display apparatus 10 sets the gamma correction value in accordance with a display source, providing a gamma correction function suitable for a case wherein the quality of image data is inferior to the display ability of the LCD 4.

(Second Embodiment)

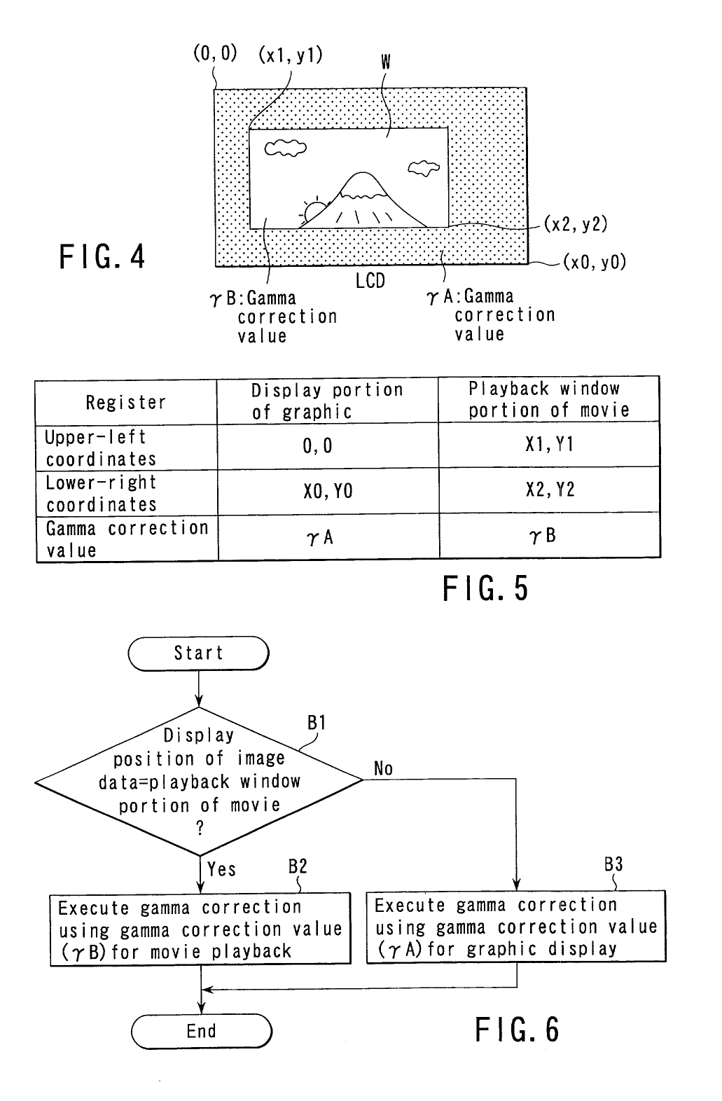

The second embodiment of gamma correction executed by an LCD controller 3 will be described with reference to FIGS. 4 and 5.

This embodiment assumes a case wherein an image made up of a playback portion of a movie and a display portion of a graphic is to be displayed on an LCD 4, as shown in FIG. 4. The MPU 1 opens a window W of a size from upper-left coordinates (x₁, y₁) to lower-right coordinates (x₂, y₂) in part of a display region of a size from upper-left coordinates (0, 0) to lower-right coordinates (x₀, y₀), and plays back the movie within the window W while displaying, e.g., wallpaper, outside the window W.

In this case, the gamma correction value used for gamma correction performed by the LCD controller 3 is preferably set to values respectively suitable for a region where the movie is played back and a region where the graphic is displayed. In the image display apparatus, therefore, the LCD controller 3 comprises a register capable of storing values as shown in FIG. 5, stores each value supplied from the MPU 1 in this register, and executes gamma correction in accordance with the register value.

More specifically, the MPU 1 transfers to the LCD controller 3 the upper-left coordinates (0, 0) and lower-right coordinates (x₀, y₀) of the display portion of the graphic, the upper-left coordinates (x₁, yₗ) and lower-right coordinates (x₂, y₂) of the playback window portion of the movie, and their gamma correction values (γ_{A}, γ_{B}) The LCD controller 3 stores these values transferred from the MPU 1 in the register, and executes conversion of image data received from a decoder 2 with reference to the register. The rectangular region defined by the coordinates (x₁, y₁) and coordinates (x₂, y₂) undergoes gamma correction using a gamma correction value for movie playback, and the remaining region undergoes gamma correction using a gamma correction value for graphic display. FIG. 6 is a flow chart showing the operation procedures of gamma correction in the second embodiment.

Since different gamma correction values can be set for respective display regions, respective images to be simultaneously displayed on a single display screen can be displayed with proper colors.

(Third Embodiment)

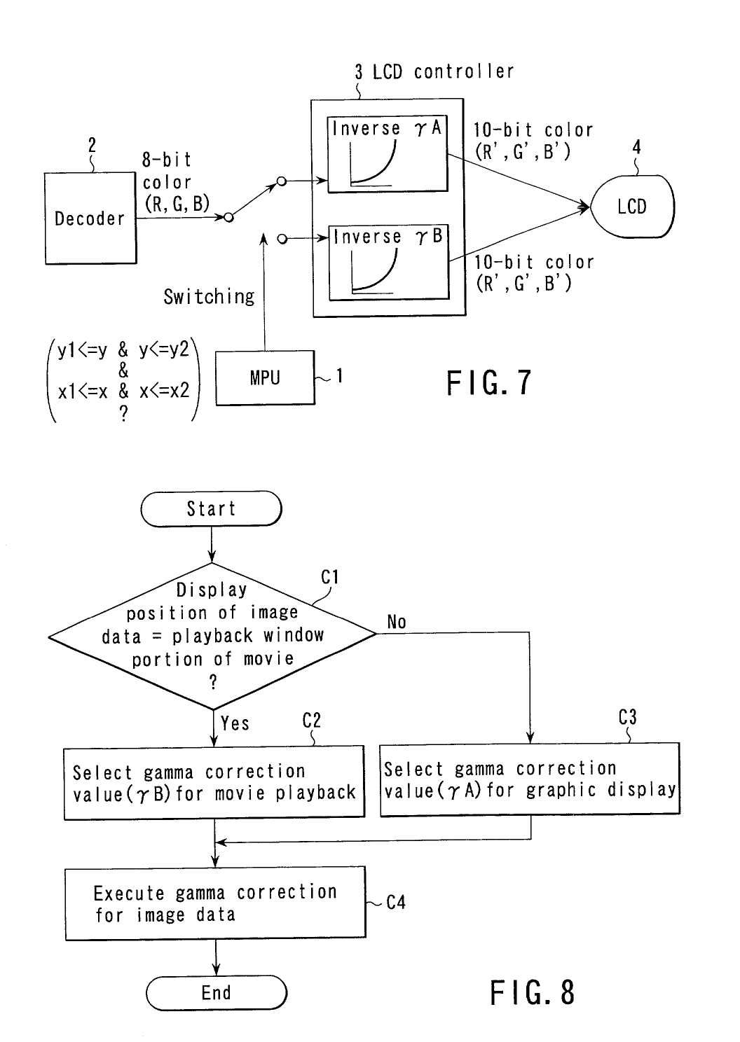

The third embodiment of gamma correction executed by an LCD controller 3 will be described with reference to FIG. 7.

This embodiment assumes a case wherein the gamma correction value of the LCD controller 3 cannot be controlled from an MPU 1. In this image display apparatus, predetermined gamma correction values (e.g., gamma correction value (γ_{A}) for movie playback and gamma correction value (γ_{B}) for graphic display) are prepared. The MPU 1 selects any gamma correction value from these gamma correction values for each coordinate on the display screen.

To display on an LCD 4 an image made up of a playback portion of a movie and a display portion of a graphic, as shown in FIG. 4 according to the second embodiment, the MPU 1 executes switching so as to select the gamma correction value (γ_{A}) for movie playback when image data output from a decoder 2 is one for movie playback within the window, and executes switching so as to select the gamma correction value (γ_{B}) for graphic display when image data output from the decoder 2 is one for graphic display outside the window. FIG. 8 is a flow chart showing the operation procedures of gamma correction in the third embodiment.

By selecting the most suitable gamma value from a plurality of gamma correction values prepared in advance for each coordinate on the display screen, respective images to be simultaneously displayed on a single display screen can be displayed with proper colors almost similarly to a case wherein the gamma correction value can be arbitrarily set.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image display apparatus comprising:
a display device;
a gamma correction value setting device configured to set a gamma correction value used to correct image data in accordance with an input/output characteristic of said display device; and
a gamma correction device configured to execute gamma correction for image data by using the gamma correction value set by said gamma correction value setting device.

2. An apparatus according to claim 1, wherein said gamma correction value setting device sets different gamma correction values for a plurality of portions segmented on a single display screen.

3. An image display apparatus comprising:
a display device;
a gamma correction value holding device configured to hold a plurality of gamma correction values used to correct image data in accordance with an input/output characteristic of said display device;
a gamma correction value selecting device configured to select a gamma correction value from the plurality of gamma correction values held by said gamma correction value holding device for each coordinate on a display screen of said display device for displaying each image data; and
a gamma correction device configured to execute gamma correction for image data by using the gamma correction value selected by said gamma correction value selecting device.

4. An image display apparatus comprising:
a display device; and
a color conversion device configured to execute color conversion by gamma correction for image data when the number of colors of image data is smaller than the number of displayable colors of said display device.

5. An image display method comprising:
setting a gamma correction value used to correct image data in accordance with an input/output characteristic of a display device; and
executing gamma correction for image data by using the set gamma correction value.

6. A method according to claim 5, wherein the gamma correction value is set for each of a plurality of portions segmented on a single display screen.

7. An image display method comprising:
holding a plurality of gamma correction values used to correct image data in accordance with an input/output characteristic of a display device;
selecting a gamma correction value from the plurality of held gamma correction values for each coordinate on a display screen of the display device for displaying each image data; and
executing gamma correction for image data by using the selected gamma correction value.

8. An image display method comprising:
executing color conversion by gamma correction for image data when the number of colors of image data is smaller than the number of displayable colors of a display device.
